(19) United States
(12) Patent Application Publication
(10) Pub. No.: US 2012/0320522 A1
(43) Pub. Date: Dec. 20, 2012

(54) MOUNTING APPARATUS FOR FAN

(75) Inventors: YUN-LUNG CHEN, Tu-Cheng (TW); CHUNG CHAI, Tu-Cheng (TW)

(73) Assignee: HON HAI PRECISION INDUSTRY CO., LTD., Tu-Cheng (TW)

(21) Appl. No.: 13/402,961

(22) Filed: Feb. 23, 2012

(30) Foreign Application Priority Data
Jun. 14, 2011 (CN) 201110158989.5

(51) Int. Cl. G06F 1/20

(52) U.S. Cl. 361/679.48

(57) ABSTRACT

A mounting assembly includes a fan and a plate. The fan includes a locking pin, which includes a wedge portion and a locking portion. The plate defines a ventilation area corresponding to the fan. A securing hole is defined by the plate and adjacent a corner of the ventilation area. The securing hole includes a wide portion and a narrow portion. The positioning piece is located on the plate. The locking portion is inserted through the wide portion and locked on the plate at the narrow portion. The wedge portion is wedged in the narrow portion, and the positioning piece abuts an edge of the fan to prevent the locking pin moving out of the securing hole.

### BACKGROUND

1. Technical Field

The present disclosure relates to mounting apparatuses for fans, more particularly, to a mounting apparatus which can conveniently and firmly secure a fan to a computer enclosure.

2. Description of Related Art

Computers include a central processing unit (CPU) and a power supply. Heat generated from the CPU may be removed from the CPU by a fan attached to the CPU. There is usually a fan for the power supply to assist in cooling the power supply as well.

The fans are generally mounted in the computer enclosures by screws which require the use of a tool. Attaching the fans to the computer enclosure may be tedious and inconvenient, especially when the enclosure is small. Furthermore, other components in the enclosure may be prone to be accidentally damaged during the attachment procedure.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded and isometric view of a mounting apparatus and a fan of an embodiment.

FIG. 2 is an enlarged view of the encircled portion II of FIG. 1.

FIG. 3 is an isometric view of the fan of FIG. 1.

FIG. 4 is an enlarged view of the encircled portion IV of FIG. 3.

FIG. 5 is an assembled view of the mounting apparatus and the fan of FIG. 1.

FIG. 6 is another assembled view of the mounting apparatus and the fan of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

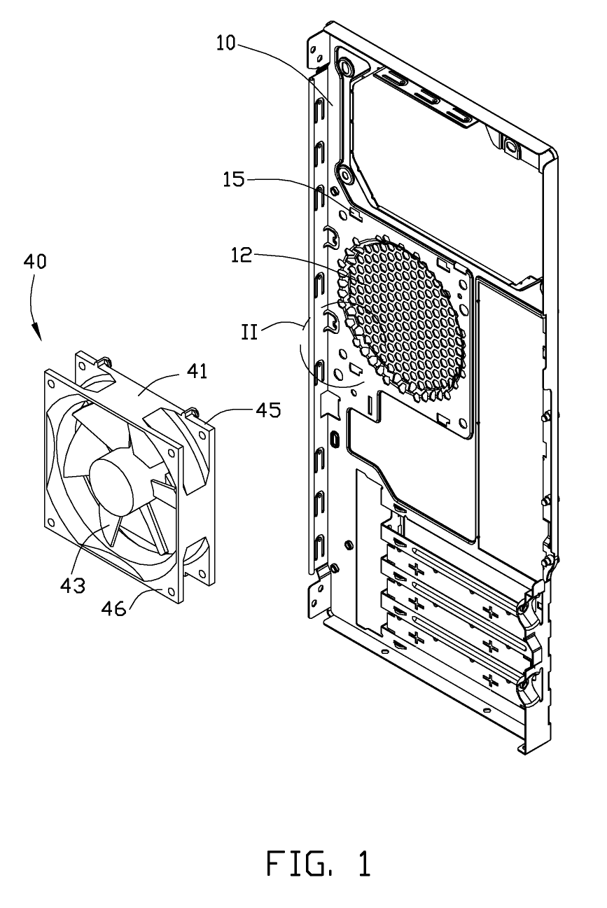

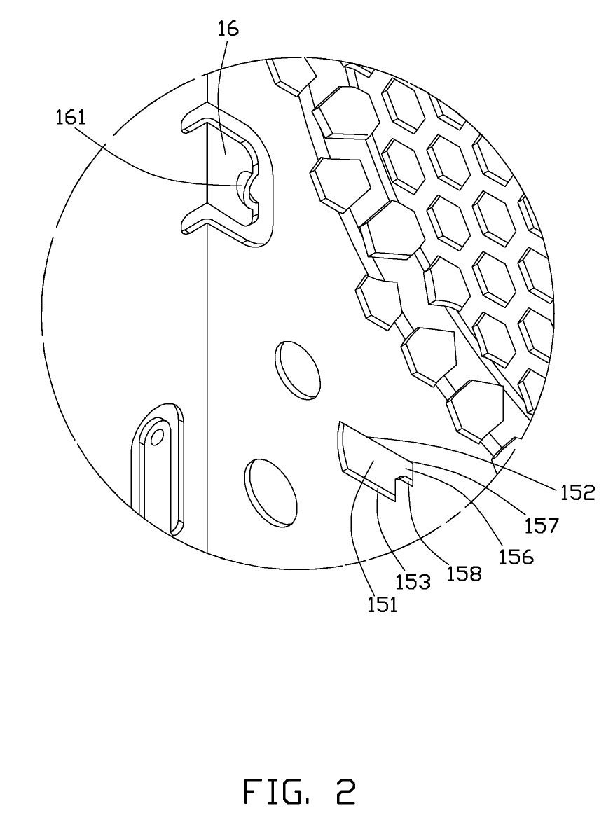

Referring to FIGS. 1 and 2, a mounting apparatus in accordance with an embodiment includes a plate 10. The mounting apparatus is used to mount a fan 40 on the plate 10.

The plate 10 defines a plurality of vents thereof to form a generally circular ventilation area 12 for air movement through the plate 10. A securing hole 15 is located adjacent each corner of the ventilation area 12. The securing hole 15 includes a wide portion 151 and a narrow portion 156 which communicates with the wide portion 151. The wide portion 151 includes a first edge 152 and another first edge 153 opposite to the first edge 152. The narrow portion 156 includes a second edge 157 and another second edge 158 opposite to edge 157. The first edge 152 and the second edge 157 are located in a same plane. The first edge 153 and the second edge 158 are located in different plane. An edge of the wide portion 151, which is far away from the narrow portion 156, is arc-shaped. A pair of positioning pieces 16 is formed on the plate 10 and located adjacent a side of the ventilation area 12. A protrusion 161 is formed on each of the pair of positioning pieces 16.

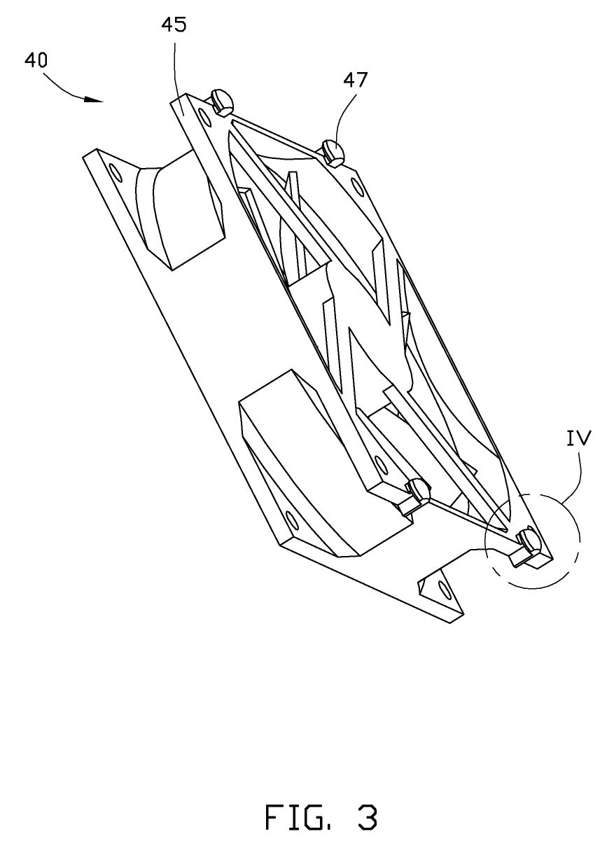

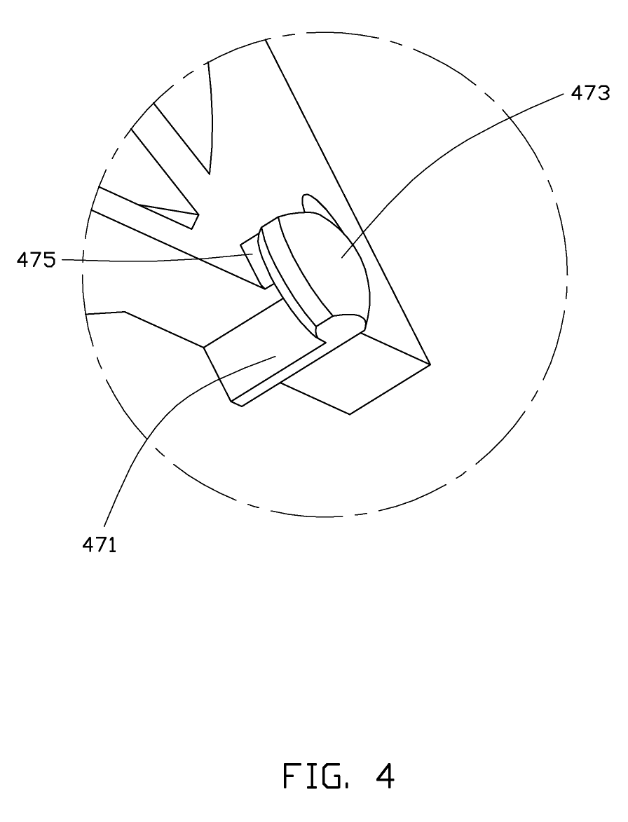

Referring to FIGS. 1, 3, and 4, the fan 40 includes a frame 41 and a plurality of blades 43 rotatably mounted in the frame 41. The frame 41 includes a first piece 45 and a second piece 46. Each of upper and bottom edges of the first piece 45 forms a pair of locking pins 47. Each of the pair of locking pins 47 includes a connection portion 471, a locking portion 473 and a wedge portion 475. The connection portion 471 is connected to the upper or bottom edges of the first piece 45. The connection portion 471 extrudes over the upper or the bottom edges. The locking portion 473 is connected to a distal end of the connection portion 471. A size of the locking portion 473 is larger than that of the connection portion 471. A part of the locking portion 473 is located above or below the upper edge or bottom edge of the first piece 45. The wedge portion 475 is connected between the first piece 45 and the locking portion 473. A width of the locking portion 473 is smaller than that of the wide portion 151, and larger than that of the narrow portion 156. A width of the wedge portion 475 is smaller than that of the narrow portion 156.

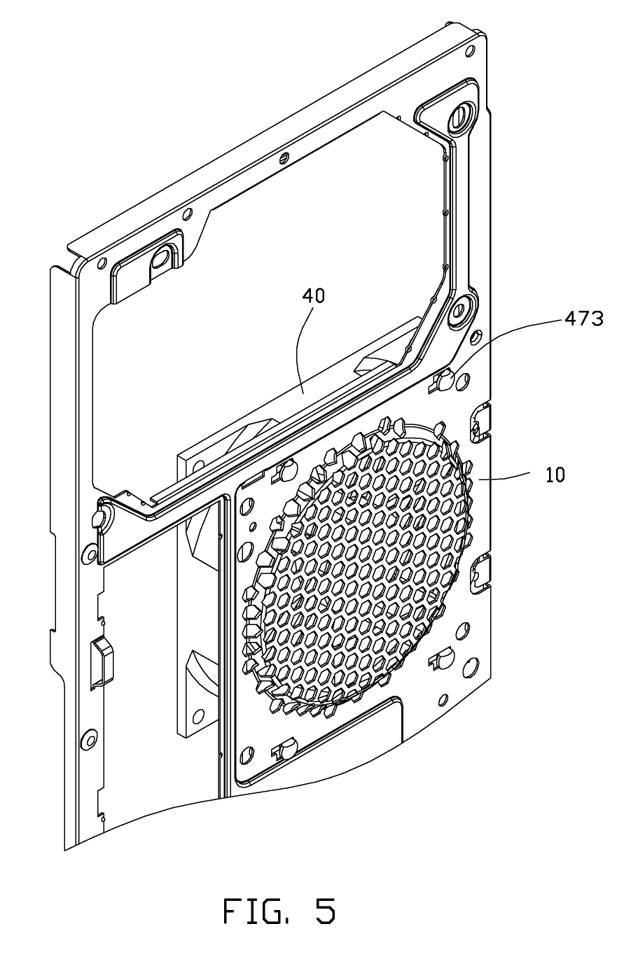

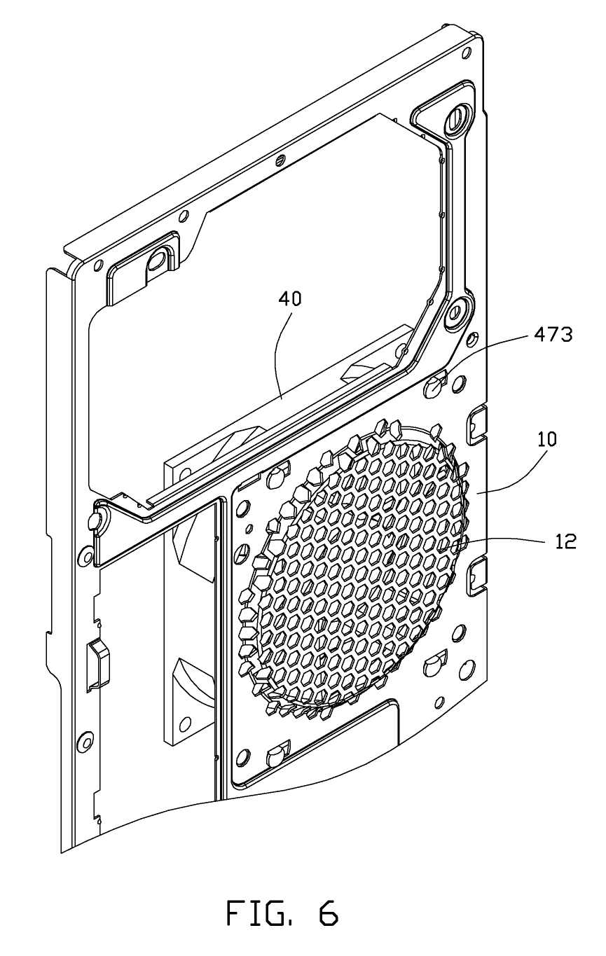

Referring to FIGS. 1 to 6, to mount the fan 40, each of the pair locking pins 47 of the fan 40 is aligned to the wide portion 151 of the securing hole 15. The locking portion 473 extends through the securing hole 15. Because one edge of the wide portion 151 is arc-shaped, the locking portion 473 is easily extended through the securing hole 15. The wedge portion 475 is located in the wide portion 151. At this position, the first piece 45 of the fan 40 rides on top of each of the pair of positioning pieces 16. The fan 40 is moved sideways on the plate 10. The wedge portion 475 is wedged in the narrow portion 156 of the securing hole 15. The first piece 45 slides over each of the pair of positioning pieces 16 and drops onto the plate 10 as the wedge portion 475 reaches an end of the narrow portion 156. The protrusion 161 abuts an edge of the first piece 45 to stop the fan 40 sliding back. Simultaneously, the locking portion 473 of each of the pair of locking pins 47 is captive on the outside of the plate 10, and the fan 40 is mounted on the plate 10. The fan 40 is aligned to the ventilation area 12.

To disassemble the fan 40, the first piece 45 is lifted above the protrusion 161. The wedge portion 475 is then able to slide from the narrow portion 156 to the wide portion 151. The pair of locking pins 47 can be pulled out of the securing holes 15 to detach the fan 40 from the plate 10.

In the above mounting apparatus, the pair of locking pins 47 are integrally formed on the fan 40, and additional securing elements are not used.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the invention to the full extent indicated by the broad general meaning of the terms in which the appended claims are expressed.

What is claimed is:

1. A mounting assembly, comprising:
a fan comprising a locking pin, the locking pin comprising a wedge portion and a locking portion; and
a plate comprising a positioning piece, a ventilation area corresponding to the fan, and a securing hole defined in the plate and adjacent a corner of the ventilation area; the securing hole comprising a wide portion and a narrow portion;
wherein the locking portion is configure to be inserted through the wide portion and locked on the plate at the narrow portion, the wedge portion is configure to be wedged in the narrow portion, and the positioning piece abuts an edge of the fan to prevent the locking pin from moving out of the securing hole.

2. The mounting assembly of claim 1, wherein the wide portion comprises two first edges opposite to each other, the narrow portion comprises two second edges opposite to each other, one of the two first edges and one of the two second edges are located in a same plane, and another one of the two first edges and another one of the two second edges are located in different planes.

3. The mounting assembly of claim 1, wherein the locking pin comprises a connection portion, the fan comprises a first piece, the connection portion is connected to an edge of the first piece, the connection portion extrudes over the edge of the first piece, and the locking portion is connected to a distal end of the connection portion.

4. The mounting assembly of claim 3, wherein the wedge portion is connected between the edge of the first piece and the locking portion.

5. The mounting assembly of claim 1, wherein the fan is aligned to the ventilation area.

6. The mounting assembly of claim 1, wherein the locking pin is integrally formed on the fan.

7. The mounting assembly of claim 1, wherein the narrow portion is interconnected with the wide portion, and an edge of the wide portion away from the narrow portion is arc-shaped.

8. The mounting assembly of claim 1, wherein a protrusion is formed on the positioning piece.

9. A mounting assembly, comprising:
a fan comprising a frame, the frame comprising a first piece, a locking pin located on a corner of the first piece; and
a plate defining a ventilation area corresponding to the fan, the plate comprising a securing hole and a positioning piece, and the securing hole and the positioning piece are separated by the ventilation area;
wherein the fan is aligned to the ventilation area, the locking pin is secured in the securing hole, the first piece is located on the plate, and the positioning piece abuts an edge of the fan to prevent the locking pin from moving out of the securing hole.

10. The mounting assembly of claim 9, wherein the locking pin comprising a wedge portion and a locking portion, the securing hole comprising a wide portion and a narrow portion, the locking portion is configured to be inserted through the wide portion and locked on the plate at the narrow portion, and the wedge portion is configure to be wedged in the narrow portion.

11. The mounting assembly of claim 10, wherein the wide portion comprises two first edges opposite to each other, the narrow portion comprises two second edges opposite to each other, one of the two first edges and one of the two second edges are located in a same plane, and another one of the two first edges and another one of the two second edges are located in different planes.

12. The mounting assembly of claim 10, wherein the locking pin comprises a connection portion, the fan comprises a first piece, the connection portion is connected to an edge of the first piece, the connection portion extrudes over the edge of the first piece, and the locking portion is connected to a distal end of the connection portion.

13. The mounting assembly of claim 12, wherein the wedge portion is connected between the edge of the first piece and the locking portion.

14. The mounting assembly of claim 10, wherein the narrow portion is interconnected with the wide portion, and an edge of the wide portion away from the narrow portion is arc-shaped.

15. The mounting assembly of claim 9, wherein the locking pin is integrally formed on the fan.

16. The mounting assembly of claim 9, wherein a protrusion is formed on the positioning piece.
